(19) United States
(12) Patent Application Publication
(10) Pub. No.: US 2003/0066879 A1
(43) Pub. Date: Apr. 10, 2003

(54) Security system and method for transaction cards

(76) Inventor: Pamela Robin Cummins, Port Macquarie (AU)

Correspondence Address: David P. Gordon, 65 Woods End Road, Stamford, CT, 06905, US

(21) Appl. No.: 10/035,460

(22) Filed: Oct. 26, 2001

(30) Foreign Application Priority Data
Oct. 10, 2001 (AU) PR8191

(51) Int. Cl. G06K 5/00

(52) U.S. Cl. 235/380

(57) ABSTRACT

A transaction card for financial transactions has a data carrier encoded with information identifying an associated financial institution, and visible information identifying a transaction card type and card holder's name but not including visible identification of one or more of the issuing financial institution, expiry date and account number of the card. A financial transaction system using said card is also disclosed.

### BACKGROUND OF THE INVENTION

1. Field of the Invention

The following invention relates to transaction cards such as credit cards, debit cards, ATM (Automatic Teller Machine) cards and other cards that might be used over the counter and/or with machines or other devices such as card readers to transact funds.

2. State of the Art

Transaction cards require entry of a PIN (Personal Identification Number), or other security code as a security measure to initiate a transaction at ATMs or when making a purchase where one slides his or her own card through a card reader associated with a key pad such as in supermarkets or other stores, for example.

The transaction card typically has printed and/or embossed thereon a significant amount of information about the bearer and the financial institution, including the brand of transaction card, the bearer's first and last names, the name and address of issuing institution, account number and expiry date. The card also contains a sample signature and a magnetic strip or other readable data carrier with encoded account information.

Where a credit card is used to purchase goods for example, only a signature is required for verification. A PIN or other security code is not required for this type of transction. Therefore any person capable of forging a signature appearing on a stolen card can use the card to make a purchase, using the information printed on the card. Furthermore, the account number and other information on the card is believed by the inventor to provide increased opportunities for fraud.

It is the object of the present invention to overcome or substantially ameliorate at least one of the above disadvantages and/or more generally to provide an alternative security system for transaction cards.

### SUMMARY OF THE INVENTION

There is disclosed herein a transaction card for financial transactions, said card including a data carrier encoded with information identifying a financial institution with which said card is associated, and visible information identifying a transaction card type and card holder's name, said card not including visible identification of issuing financial institution, expiry date and account number of the card.

A further form of the invention provides a financial transaction system including

a transaction card issued by a financial institution, said card including a data carrier encoded with information identifying a financial institution with which said card is associated, and visible information identifying a transaction card type and card holder's name, said card not including visible identification of issuing financial institution, expiry date and account number of the card,

a card reader at a transaction location, and

a transaction processing computer in communication with said card reader for processing a transaction.

Preferably, an associated security code, entry of which is required by a card holder to perform a transaction when using the card with ATMs or other devices, is generated by the card issuer derived from the date of birth of the card holder's mother or father.

Typically, the code is derived from only the day and month of the date of birth of the card holder's mother or father.

Preferably also, the information encoded on the card is encrypted form, for decoding by the transaction processing computer when process the transaction.

The card holder's mother or father's date of birth data might be held in a database, having been placed there upon opening of the account with which the card is associated. Other information held in the database might include the card holder's mother's maiden name for example.

### DETAILED DESCRIPTION OF THE PREFERRED EMBODIMENTS

Known transaction cards are encoded with a magnetic strip to identify the account or accounts with which the card is associated. The account information is also printed on the card. Information is held in a computer database and usually includes a PIN code. Entry of this code is required to commence a transaction when using the card at an ATM or when using “EFTPOS” (Electronic Funds Transfer Point of Sale) facilities at supermarkets or other stores for example.

If the card is stolen and the PIN is known by the thief, the card can readily be used. Alternatively, the account information printed and encoded on the card may be used for conducting fraudulent transactions by forgery of the signature or over the internet

In the preferred embodiment of the invention, the visible information printed on the transaction card is the brand of the card, for example Visa or MasterCard, and the name of the card holder. Preferably, the card holder's first name is shown in abbreviated form, for example “J Smith”, so that inspection of the card will not reveal the full name or gender of the card holder. Furthermore, the visible information on the card does not identify the issuing bank or other financial institution, so that the card holder's nationality is not revealed. In this way, a stolen card reveals little useful information to the thief

Preferably also, neither the account number nor expiry date is visible on the card The card may include a signature strip as usual on action cards.

The information encoded on the magnetic strip or other readable data carrier on the card preferably identifies the issuing financial institution and branch, and the card holder's name and the account number, this information being stored and transmitted in encrypted form for decoding by institution's computer processing system when processing a transaction.

By generating a security code derived at least in part from to the date of birth of the card holder's mother or father, this code can readily be recalled by the legitimate card holder and entered as a security measure at an ATM or card reader or during an across the counter transaction. A thief would not necessarily know the date of birth data, and would have no opportunity to find out this information due to the lack of information on the card.

The security code preferably also contains a portion derived from the card holder's gender, for example the digits 01 for a male or 02 for female.

The code derived from the birth date and gender is preferably used as the primary security code for the card. However, in less preferred forms of the invention may be a secondary security code, with the primary encoding being an ordinary PIN, but the secondary encoding being something like “0322” to identify the date of birth of a card holder's mother or father born on 22 March. The entry of this code would be required as a primary or secondary security measure to complete a transaction at an ATM or EFT terminal. Without both the signature and/or code, the transaction will be withheld by the bank's computer software.

It should be appreciated that the date-derived PIN or other security code need not be exactly as stated above but might simply be “derived” from the date of birth of the card holder's mother or father. It might, for example, just be in relation to the month and day of the month for card holders not willing to divulge their age at every across the counter transaction. For example, for the birth date given above the derived security code may be 032201 for a male card holder or 032202 for female.

It should be appreciated that alterations to this system that are obvious to those skilled in the art are not to be considered as beyond the scope of the invention. For example, the encoding might also include a check digit as a further security measure against unauthorised use. It will also be understood that reference to the birth date of the card holder's mother or father includes reference to the birth date of a guardian or a step-mother or step-father.

It should further be appreciated that where people carry multiple cards and have multiple accounts, these often have different PINs and it can be difficult and confusing to remember them all. As a result, and despite requests from the financial institutions issuing the cards, it is common for people to keep written record of their various PINs in their wallet or purse. This presents a substantial risk of fraudulent use of the card if the wallet or purse is lost or stolen. In the present invention, the PIN being a derivation of one of the card holder's parents date of birth would be easy to remember by the legitimate card holder. There would be further advantages in that there would be no need for the card holder to write this number down on material kept with their wallet or purse as it would be readily recalled anyway.

As a preferred or optional feature, an ATM might be pre-programmed to retain the transaction card, should a user not be able to key in the security code.

At an ATM or EFT terminal, swiping the card will cause transfer in encrypted form of the encoded institution identity and branch information, account number and the card holder's name, the latter preferably encoded in the same abbreviated form as shown on the card, will be passed to the computer system of the issuing financial institution for verification. The account holder will be required to enter the PIN and this is transmitted to the verifying computer and verified against the account and holder's information. Where a match is verified, access to the account identified by those matching particulars is granted and the permission to continue with the transaction approved.

If the holder's purse or wallet is stolen, the transaction card would have insufficient information, either printed or encoded to be of use or value to a thief, even over the internet or telephone where the security code is not normally required to complete a transaction. If the thief then attempted to use the card to purchase goods over the counter or at an ATM or EFT terminal without the PIN, the transaction could not be completed as the account number could not be accessed. Furthermore, the information on the magnetic strip is encrypted for decoding by the processing computer, making this information of no use to a thief.

Where a card holder expressly wishes to use the account for internet or telephone transactions, an additional telephone banking card may be issued which does display an account number and expiry date. Such card would have no less security than present transaction cards, but as the need for that card would rarely arise while travelling, where card theft and fraudulent transactions are prevalent, that card could be kept in a separate, more secure place. The card which is needed to be kept in the wallet or purse for general transactions, and thus most exposed to theft or copying, would be the more secure card containing insufficient information to allow fraud.

There is further provided a method of entering the PIN into the financial institution's database without human intervention on behalf of the financial institution:

Contrary to current practice, all application forms for issuance of a card would be individually coded with an application number or similar.

Each application form would have a “tear-off” section, containing the same coding as the body of the form. This removable section would also contain instructions for the card applicant to set up the secondary PIN by telephoning the credit provider at a specified telephone number within a specified time period (eg. 48 hours from lodging the card application), using a touch-tone phone. The instructions would explain the nature and use of the security code. The card applicant's telephone call is answered by an automated answering service which prompts the caller to enter the individual application form coding and the birth date which will form the basis for the PIN. The service will then confirm this data to the caller, for example by asking for repeat entry of the data or confirming the data by voice synthesis. The automated service may optionally then confirm to the caller the derived from the birth data and gender.

When the application is processed by the credit provider, the PIN is correlated to the card application in the database using the application form code number, thus entering the PIN into the database without intervention by staff of the credit card provider.

Alternatively, or in addition, the removable section could contain instructions for the card applicant to set up the PIN via a secure internet site. The set up information and procedure could be generally similar to that for telephone setup. For added security, the internet site may also include a field requiring entry of an extra code, which preferably is the same as the user's internet service provider access password.

Where a card applicant completes an application form and lodges it personally with the credit provider, facilities may be provided to complete this PIN set up procedure at that time. If the applicant mails in the application, the applicant will need access to a touch-tone phone or internet facilities to complete set up of the PIN.

The system may also require that the applicant upon receipt of the credit or transaction card, contacts the card provider on a specified telephone number or internet address and is prompted to key in the PIN to activate the card.

As a further precaution against transaction fraud, it is preferred that a holographic or other diffractive optical variable device covers substantially the entire front surface of the transaction card. Preferably, the hologram is embossed into a transparent holographic foil which may be applied to substantially the whole front surface of the card while permitting visibility of the graphic elements of the card.

While particular embodiments of this invention have been described, it will be evident to those skilled in the art that the present invention may be embodied in other specific forms without departing from the essential characteristics thereof. The present embodiments and examples are therefore to be considered in all respect as illustrative and not restrictive, and all modifications which would be obvious to those skilled in the art are therefore intended to be embraced therein. It will further be understood that any reference herein to known prior art does not, unless the contrary indication appears, constitute an admission that such prior art is commonly known by those skilled in the art to which the invention relates.

1. A transaction card for financial transactions, said card including a data carrier encoded with information identifying a financial institution with which said card is associated, and visible information identifying a transaction card type and card holder's name, said card not including visible identification of issuing financial institution, expiry date and account number of the card.

2. A transaction card according to claim 1 wherein said encoded information further includes identification of an account number being stored in encrypted form capable of decoding by a transaction processing computer.

3. A transaction card according to claim 1 wherein said card does not include visible identification of the account number.

4. A transaction card according to claim 3 wherein said card does not include visible identification of the account number and expiry date.

5. A transaction card according to claim 3 wherein said card does not include visible identification of the account number and the issuing financial institution.

6. A transaction card according to claim 5 wherein said card further does not include visible identification of the expiry date.

7. A financial transaction system including
a transaction card issued by a financial institution, said card including a data carrier encoded with information identifying a financial institution with which said card is associated, and visible information identifying a transaction card type and card holder's name, said card not including visible identification of issuing financial institution, expiry date and account number of the card,
a card reader at a transaction location, and
a transaction processing computer in communication with said card reader for processing a transaction.

8. A transaction system according to claim 7 further including a security code associated with said card and required for processing of the transaction, said security code being generated by a card issuer derived from date of the card holder's mother or father.

9. A transaction system according to claim 7 wherein said encoded information further includes identification of an account number being stored in encrypted form capable of decoding by a transaction processing computer.

10. A transaction system according to claim 7 wherein said card does not include visible identification of the account number.

11. A transaction system according to claim 10 wherein said card does not include visible identification of the account number and expiry date.

12. A transaction system according to claim 10 wherein said card does not include visible identification of the account number and the issuing financial institution.

13. A transaction system according to claim 12 wherein said card further does not include visible identification of the expiry date.
